(19) United States
(12) Patent Application Publication
(10) Pub. No.: US 2020/0274840 A1
(43) Pub. Date: Aug. 27, 2020

(54) ARCHITECTURE FOR DEFINING GROUP MESSAGING

(71) Applicant: SMARTSKY NETWORKS LLC, Morrisville, NC (US)

(72) Inventor: Jason Natwick, Charlotte, NC (US)

(21) Appl. No.: 16/649,330

(22) PCT Filed: Sep. 19, 2018
(86) PCT No.: PCT/US2018/051629

§ 371 Date: Mar. 20, 2020

Related U.S. Application Data
(60) Provisional application No. 62/561,390, filed on Sep. 21, 2017.

(51) Int. Cl. H04L 12/58; H04W 8/24; H04W 4/12; H04B 7/185

(52) U.S. Cl. CPC H04L 51/14; H04W 8/24; H04L 67/12; H04B 7/18506; H04W 4/12

(57) ABSTRACT

A grouping agent may include processing circuitry configured to receive a device identifier of a communication device associated with a transportation asset, define a communication group including the communication device and one or more other communication devices also associated with the transportation asset, and enable communication of a message to the communication group on the transportation asset.

### CROSS REFERENCE TO RELATED APPLICATION

This application claims priority to U.S. application No. 62/561,390 filed Sep. 21, 2017, the entire contents of which are hereby incorporated by reference in its entirety.

### TECHNICAL FIELD

Example embodiments generally relate to wireless communications and, more particularly, relate to techniques for enabling group messaging to be conducted by wireless network operators (e.g., air-to-ground (ATG) network operators) and their partners based on individual transportation assets.

### BACKGROUND

High speed data communications and the devices that enable such communications have become ubiquitous in modern society. These devices make many users capable of maintaining nearly continuous connectivity to the Internet and other communication networks. Although these high speed data connections are available through telephone lines, cable modems or other such devices that have a physical wired connection, wireless connections have revolutionized our ability to stay connected without sacrificing mobility.

However, in spite of the familiarity that people have with remaining continuously connected to networks while on the ground, people generally understand that easy and/or cheap connectivity will tend to stop once an aircraft is boarded. Aviation platforms have still not become easily and cheaply connected to communication networks, at least for the passengers onboard. Attempts to stay connected in the air are typically costly and have bandwidth limitations or high latency problems. Moreover, passengers willing to deal with the expense and issues presented by aircraft communication capabilities are often limited to very specific communication modes that are supported by the rigid communication architecture provided on the aircraft.

As improvements are made to network infrastructures to enable better communications with in-flight receiving devices of various kinds, additional communication paradigms may become available beyond the familiar communication paradigm of enabling individual communication assets to be located within the network and communicated with by other communication assets in a one-to-one communication link. Group messaging may be one such additional communication paradigm that may be desirable to implement.

### BRIEF SUMMARY OF SOME EXAMPLES

The continuous advancement of wireless technologies offers new opportunities to provide wireless communication to devices located on an aircraft or other transportation asset. In this regard, for example, by using communication assets located on an aircraft to provide a gateway for connection to an ATG network as a basis to define a communication group or messaging group, a temporary affinity group may be defined such that messages that may be either necessary or of interest for the communication group to receive may be issued to the communication group. For example, a ring group may be automatically defined for the aircraft even before the aircraft leaves the ground. employing various interference mitigation strategies, spectrum reuse may be employed. Pilots, passengers, or others aboard the plane could then be reached either by calling or messaging services without knowing specific information about the members of the communication group.

In one example embodiment, a network for providing air-to-ground (ATG) wireless communication in various communication cells is provided. The network may include an aircraft, a plurality of ATG base stations, and a grouping agent operably coupled to the aircraft. The grouping agent may include processing circuitry configured to receive a device identifier of a communication device associated with the aircraft, define a communication group including the communication device and one or more other communication devices also associated with the aircraft, and enable communication of a message to the communication group on the aircraft.

In another example embodiment, a grouping agent is provided. The grouping agent may include processing circuitry configured to receive a device identifier of a communication device associated with a transportation asset, define a communication group including the communication device and one or more other communication devices also associated with the transportation asset, and enable communication of a message to the communication group on the transportation asset.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a side view of a layered approach to providing wireless communication to in-flight aircraft while minimizing interference between the layers in accordance with an example embodiment;

FIG. 2 illustrates a block diagram of various devices on an aircraft being grouped as part of a communication group in accordance with an example embodiment;

FIG. 3 illustrates a functional block diagram of a grouping agent of an example embodiment; and

FIG. 4 illustrates a block diagram of a method of communicating in an ATG network in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals may be used to refer to like elements throughout. Furthermore, as used herein, the term “or” is to be interpreted as a logical operator that results in true whenever one or more of its operands are true.

Some example embodiments described herein provide architectures and methods for improved air-to-ground (ATG) wireless communication performance. In this regard, some example embodiments may provide for the ability to identify devices within a network that are associated with a specific transportation asset (e.g., an airplane) so that each such device can be added to a communication group (e.g., a ring group) for a predetermined period of time (e.g., for the duration of a scheduled flight). The communication group can be defined and utilized without any needed action on the part of the user. The communication group, which may effectively be considered to be an affinity group relative to information regarding the transportation asset and its current scheduled operation, can be used to communicate emergency information, arrival gate, baggage claim location, gate changes, arrival weather, delays, reroutes, and/or the like. Other content may also be provided to the communication group that is not necessarily related to the current scheduled operation of the transportation asset. For example, games, movies, music, surveys, advertisements, etc., may be provided to the members of the communication group via broadcast or individually based on the behavior of the members of the communication group. As a result, useful information may be provided to members of the communication group to improve their experience or improve the quality of service.

In an ATG network of an example embodiment, a plurality of base stations may be distributed to provide a corresponding plurality of adjacent wedge shaped cell coverage areas. Each wedge shaped cell may define a coverage area that extends between an upper and lower altitude limit and the upper and lower altitude limits may increase (substantially linearly) as distance from the transmitters forming the wedge shaped cell increases. Thus, the coverage areas may be defined between altitude bands that increase in size and altitude as they proceed away from the transmission site. A plurality of sectors within each wedge shaped cell may combine to form the wedge shaped cell. In some cases, six sectors may be employed to cover about 30 degrees each for a total of 180 degrees of azimuth coverage provided by each wedge shaped cell. The cell coverage area may therefore be substantially semicircular in the horizontal plane, and can be provided by multiple antennas each providing a wedge shaped sector over corresponding portions of the semicircular azimuth. The base stations can be deployed as substantially aligned in a first direction while offset in a second direction. For example, the base stations can also be deployed in the first direction at a first distance to provide coverage overlapping in elevation to achieve coverage over the predetermined altitude, and within a second distance in the second direction based on an achievable coverage area distance of the sectors. In some embodiments, any number of sectors may be employed for as much as 360 degrees of coverage.

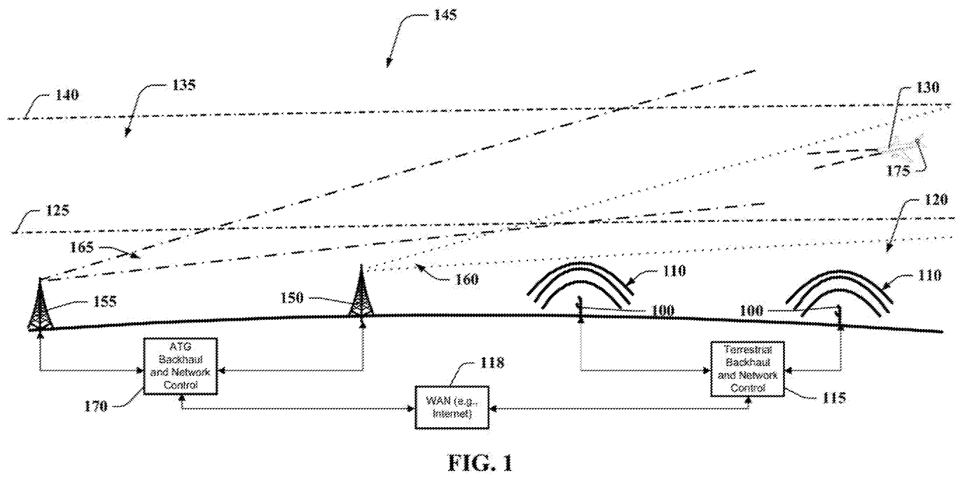

FIG. 1 illustrates an example ATG network architecture according to the description above. However, it should be appreciated that example embodiments may operate in other network architectures as well (and on other transportation assets). Referring now to FIG. 1, an ATG network architecture is illustrated for providing overlapping cells with layered altitude bands to facilitate ATG wireless communication coverage with RF spectrum that can be reused by a terrestrial network or a satellite communication network. FIG. 1 shows only two dimensions (e.g., an X direction in the horizontal plane and a Z direction in the vertical plane), however it should be appreciated that a wedge architecture of the ATG network may be structured to extend coverage also in directions into and out of the page (i.e., in the Y direction). Although FIG. 1 is not drawn to scale, it should be appreciated that the wedge shaped cells generated by the base stations for the ATG portion of the network architecture are configured to have a much longer horizontal component than vertical component. In this regard, the wedge shaped cells may have a horizontal range on the order of dozens to nearly or more than 100 miles. Meanwhile, the vertical component expands with distance from the base stations, but is in any case typically less than about 8 miles (e.g., about 45,000 ft).

As shown in FIG. 1, a terrestrial network component of the architecture may include one or more terrestrial base stations 100. The terrestrial base stations 100 may generally transmit terrestrial network emissions 110 to serve various fixed or mobile communication nodes (e.g., UEs) and other wireless communication devices dispersed on the ground. The terrestrial base stations 100 may be operably coupled to terrestrial backhaul and network control components 115, which may coordinate and/or control operation of the terrestrial network. The terrestrial backhaul and network control components 115 may generally control allocation of RF spectrum and system resources, and provide routing and control services to enable the UEs and other wireless communication devices of the terrestrial network to communicate with each other and/or with a wide area network (WAN) such as the Internet.

The UEs of the terrestrial network may also transmit their own terrestrial network emissions, which may create the possibility for generation of a substantial amount of communication traffic in a ground communication layer 120 extending from the ground to a predetermined minimum altitude 125 above which only receivers on in-flight aircraft 130 (which is an example of a transportation asset) are present. The in-flight aircraft 130 may operate in an ATG communication layer 135 that may extend from one or two miles in altitude up (e.g., the predetermined minimum altitude 125) to as far as about 8 miles in altitude (e.g., a predetermined maximum altitude 140). The predetermined minimum altitude 125 and predetermined maximum altitude 140 may bound a single ATG communication layer or, in the case where multiple ATG wedge shaped cells overlap, multiple ATG communication layers. Although not required, in some examples, a high altitude communication layer 145 may be defined above the maximum altitude 140. The high altitude communication layer 145 may include assets such as drones or satellites that may communicate either intra-layer or cross-layer with other assets within the network either in parallel or in combination with the other components described herein.

The architecture may also employ a first ATG base station 150 and a second ATG base station 155, which are examples of base stations employed in an ATG network to define wedge shaped cells. Thus, for example, the first ATG base station 150 may be deployed substantially in-line with the second ATG base station 155 along the X axis and may generate a first wedge shaped cell 160 that may be layered on top of a second wedge shaped cell 165 generated by the second ATG base station 155. When the in-flight aircraft 130 is exclusively in the first wedge shaped cell 160, the in-flight aircraft 130 may communicate with the first ATG base station 150 using assigned RF spectrum and when the in-flight aircraft 130 is exclusively in the second wedge shaped cell 165, the in-flight aircraft 130 may communicate with the second ATG base station 155 using assigned RF spectrum. An area of overlap between the first wedge shaped cell 160 and the second wedge shaped cell 165 may provide the opportunity for handover of the in-flight aircraft 130 between the first ATG base station 150 and the second ATG base station 155, respectively. Accordingly, uninterrupted handover of receivers on the in-flight aircraft 130 may be provided while passing between coverage areas of base stations having overlapping coverage areas as described herein.

In an example embodiment, ATG backhaul and network control components 170 may be operably coupled to the first and second ATG base stations 150 and 155. The ATG backhaul and network control components 170 may generally control allocation of RF spectrum and system resources, and provide routing and control services to enable the in-flight aircraft and any UEs and other wireless communication devices thereon to communicate with each other and/or with a wide area network (WAN) such as the Internet.

Given the curvature of the earth and the distances between base stations of the ATG network, the layering of the wedge shaped cells can be enhanced. Additionally, the first ATG base station 150 and the second ATG base station 155 may be configured to communicate with the in-flight aircraft 130 using relatively small, directed beams that are generated using beamforming techniques. The beamforming techniques employed may include the generation of relatively narrow and focused beams. Thus, the generation of side lobes (e.g., radiation emissions in directions other than in the direction of the main beam) that may cause interference with communications in the ground communication layer 120 may be reduced. In some cases, the terrestrial base stations 100, which are generally only required to transmit in a relatively narrow layer close to the ground, may also be configured to employ antennas and/or arrays that employ side lobe suppression techniques aimed at reducing the amount of potential interference transmitted out of the ground communication layer 120 and into the ATG communication layer 135.

Accordingly, the network architecture itself may help to reduce the amount of cross-layer interference. In this regard, the wedge shaped cell structure focuses energy just above the horizon and leaves a layer on the ground that is usable for terrestrial network operations without significant interference from the ATG base stations, and create a separate higher altitude layer for ATG network communications. Additionally, the use of directional antennas with beamsteering by the ATG base stations, and antennas with side lobe suppression, reduces the amount of interference across these layers. However, as will be described in greater detail below, since all of the equipment in the ATG communication layer 135 with which communication is desired will be on the in-flight aircraft 130, some embodiments may employ further interference mitigation techniques associated with the antenna assembly 175 provided on the in-flight aircraft 130. Accordingly, for example, the UEs or other wireless communication devices on or associated with the in-flight aircraft 130 may be communicatively coupled with the first ATG base station 150 or the second ATG base station 155 via the antenna assembly 175 of the in-flight aircraft 130. In this regard, for example, the antenna assembly 175 may be strategically mounted on the in-flight aircraft 130 and/or the antenna assembly 175 may be operated or controlled in a manner that facilitates interference mitigation as described in greater detail below.

By generally minimizing cross-layer interference, the same RF spectrum can be reused in both the ground communication layer 120 and the ATG communication layer 135. As such, the network architecture of an example embodiment may effectively act as a frequency spectrum doubler in that spectrum that is used in the terrestrial network may be reused by the ATG network with minimal interference therebetween. The base stations serving each respective layer may be distally located relative to each other such that, for example, a serving ATG base station in communication with the in-flight aircraft 130 is geographically located outside a coverage area of each of the terrestrial base stations in a portion of the ground communication layer 120 above which the in-flight aircraft 130 is located. The substantially horizontally focused nature of the ATG base stations (150 and 155) enables them to be positioned far outside of the region below which the in-flight aircraft 130 is located. The antenna assembly 175 can therefore “look” or otherwise focus its communication efforts away from potentially interfering sources directly below the in-flight aircraft 130.

As mentioned above, devices on or associated with the in-flight aircraft 130 may be correlated with the in-flight aircraft 130 to define a communication group. The specific methods by which such definition may occur can vary. However, in one example embodiment, each device on-board the in-flight aircraft 130 may connect to on-board WiFi or another on-board communication platform. In particular, for example, the in-flight aircraft 130 may include a wireless access point 200 such as a cabin wireless access point (CWAP). Each device on-board the in-flight aircraft 130 that attempts to utilize the ATG network may need to do so via the wireless access point 200. Meanwhile, the wireless access point 200 may be operably coupled to (e.g., in direct or indirect communication with) a grouping agent 210. The grouping agent 210 may be configured to receive device identifiers (IDs) from each respective device on-board the in-flight aircraft 130 that attempts to communicate with the ATG network via the wireless access point 200 and may store the device IDs in association with a corresponding asset identifier of the in-flight aircraft 130 to define a communication group 215 for the communication devices on the in-flight aircraft 130. Thus, the communication group 215 may include all of the device IDs provided for the devices on-board the in-flight aircraft 130.

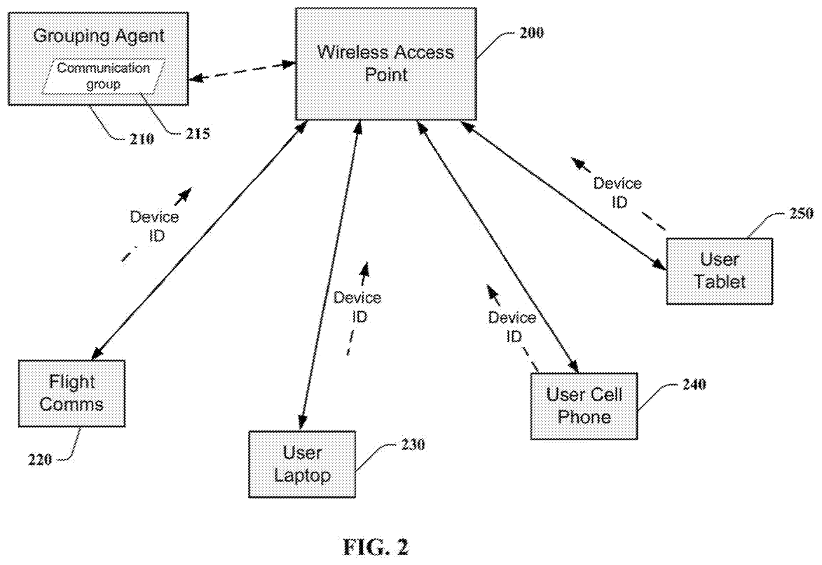

For example, as shown in FIG. 2, one or more devices of a first type (e.g., a flight communication device 220 of the pilot or other personnel or equipment associated with the in-flight aircraft 130) may provide a corresponding device ID to the wireless access point 200. At any point before or after this, one or more other types of devices (e.g., user lap top 230, user cell phone 240, user tablet 250, etc.) may each attempt to connect to the wireless access point 200 and provide corresponding device IDs thereto. The wireless access point 200 may communicate the device IDs to the grouping agent 210, and the grouping agent 215 may define the communication group 215 to include all of the device IDs.

The device IDs may include or otherwise be a telephone number, an international mobile subscriber identity (IMSI) number or international mobile equipment identity (IMEI) number for the corresponding device. Alternatively or additionally, regardless of the form that the device ID itself takes, the device ID may be stored in association with a telephone number for the device, an email address, or other such address to provide a means by which to contact the user of the device by phone call, SMS message, email or the like. Thus, once the communication group 215 is defined, the device ID provides a means by which the corresponding device may be contacted with selected messages.

In some embodiments, the grouping agent 210 may be located at the ATG backhaul and network control 170 portion of the system of FIG. 1. However, it is possible for the grouping agent 210 to be located elsewhere in the system as well. For example, in some cases, one instance of the grouping agent 210 may be provided on-board each aircraft to define the communication group 215 for each respective aircraft and communicate information regarding the communication group 215 to another instance of the grouping agent 210 located on the ground. In such an example, the instance on the ground may interface with external entities and/or generate content to be shared with the communication groups of various aircraft and may communicate with the communication groups of each respective aircraft through the individual instances of the grouping agents located on those respective aircraft. Thus, the grouping agent 210 may be a centralized component or a distributed component with either one or multiple instances located at any of various locations throughout the network.

The grouping agent 210 may interface with or be operated by an airline associated with the in-flight aircraft 130, an operator of the ATG network, or any other suitable entities. In cases where commercial airlines are involved, input from the commercial airline regarding changes to scheduled operations of the in-flight aircraft 130 or any other information related to passengers on the in-flight aircraft 130 may be provided to the grouping agent 210 for subsequent delivery to the passengers (at least those passengers that are members of the communication group 215). In any case, the communication group 215 may be a temporally limited designation that is only applicable for a time period that the device associated with the passenger on the transportation asset is on the transportation asset.

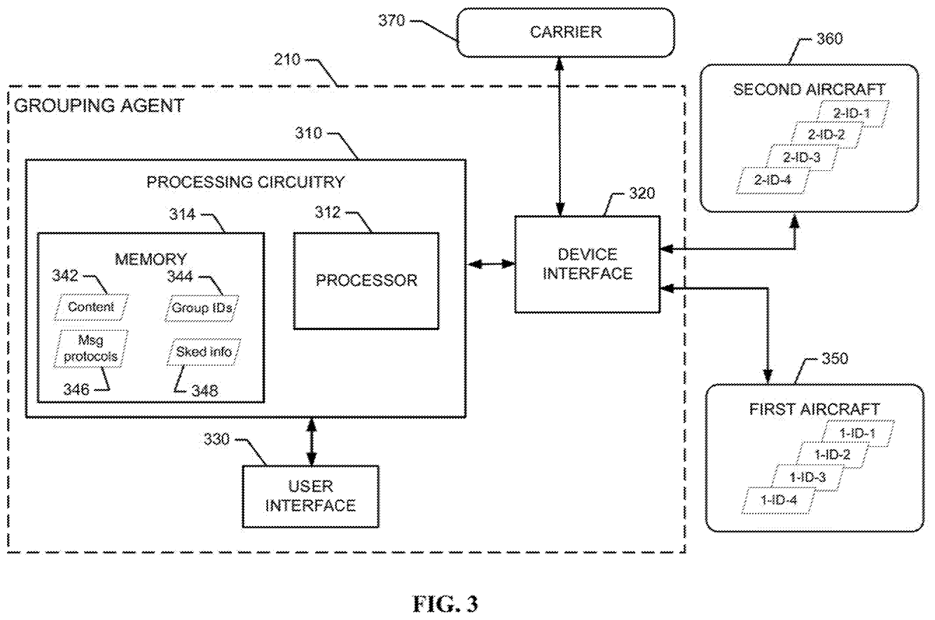

Accordingly, in some embodiments, the grouping agent 210 may further be in communication with external entities to receive information that may be of interest to the communication group 215, or the grouping agent 210 may receive or generate content that may be of interest or use to the communication group 215 without any interaction with external entities. As such, the grouping agent 210 may include various components that are configured to allow such communication and/or content sharing. As shown in FIG. 3, the grouping agent 210 may include processing circuitry 310 configured to provide control of the functions and communications provided by the grouping agent 210. The processing circuitry 310 may be configured to perform data processing, control function execution and/or other processing and management services according to an example embodiment of the present invention. In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320 and, in some cases, a user interface 330. As such, the processing circuitry 310 may be embodied as a circuit chip (e.g., an integrated circuit chip) configured (e.g., with hardware, software or a combination of hardware and software) to perform operations described herein. However, in some embodiments, the processing circuitry 310 may be embodied as a portion of an on-board computer if the grouping agent 210 is an instance associated with a particular aircraft.

The device interface 320 may include one or more interface mechanisms for enabling communication with other devices (e.g., aircraft, devices located on aircraft, external entities, etc.). In some cases, the device interface 320 may be any means such as a device or circuitry embodied in either hardware, or a combination of hardware and software that is configured to receive and/or transmit data from/to modules, entities, aircraft and/or other components of the system that are in communication with the processing circuitry 310. In the example of FIG. 3, the grouping agent 210 may be an instance located at the ground side of the network (e.g., in the ATG backhaul and network control 170 portion of the system of FIG. 1). As such, the device interface 320 may be configured to enable the grouping agent 210 to communicate with a first aircraft 350, a second aircraft 360, a carrier 370 and/or any number of additional aircraft (or grouping agents located thereon). If the grouping agent 210 were an instance located on an aircraft, then the device interface 320 may instead be configured to communicate with a ground-located instance of the grouping agent 210.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the grouping agent 210 based on inputs received by the processing circuitry 310 indicative of communication groups or information provided or generated for communication to the communication groups. As such, in some embodiments, the processor 312 (or the processing circuitry 310) may be said to cause each of the operations described in connection with the grouping agent 210 in relation to communications with the communication group 215 (or groups) to undertake the corresponding functionalities relating to such communication based on execution of instructions or algorithms configuring the processor 312 (or processing circuitry 310) accordingly. In particular, the instructions may include instructions for forming communication groups for limited times and generating, receiving, communicating, and/or handling of messages or content for delivery to the communication group 215 (or groups) during the limited times. Within this context, the limited times are the times during which the devices that form the communication group 215 are associated with the corresponding transportation asset on which their presence has been detected.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. As yet another alternative, the memory 314 may include one or more databases that may store a variety of data sets responsive to input sensors and components. Among the contents of the memory 314, applications and/or instructions may be stored for execution by the processor 312 in order to carry out the functionality associated with each respective application/instruction. In some cases, the applications may include instructions for providing inputs to control operation of the grouping agent 210 as described herein. In an example embodiment, the memory 314 may store content 342, group identity information 344, messaging protocols 346, schedule information 348, and/or the like.

In an example embodiment, the processing circuitry 310 may be configured to receive a plurality of device IDs from the first aircraft 350 (e.g., 1-ID-1, 1-ID-2, 1-ID-3, 1-ID-4, etc.) and form a first communication group (e.g., as one instance of communication group 215). The first communication group may be associated with a first group ID number as one of the communication groups included in the group identity information 344. The processing circuitry 310 may also be configured to receive a plurality of device IDs from the second aircraft 360 (e.g., 2-ID-1, 2-ID-2, 2-ID-3, 2-ID-4, etc.) and form a communication group (e.g., as a second instance of communication group 215). The second communication group may be associated with a second group ID number as another one of the communication groups included in the group identity information 344. Alternatively, one group ID number may be provided to all passengers regardless of the specific aircraft on which they are located. Other communication groups may also be defined in the group identity information 344 either with unique group ID numbers or with a single group ID number.

The processing circuitry 310 may also receive schedule information 348 from the carrier 370, including updates and changes thereto. Thus, for example, the schedule information 348 may include information indicative of arrival time, arrival gate, baggage claim belt, connecting gate information, connecting flight status, etc. However, the schedule information 348 may be tailored to the individual communication group to which it pertains. Thus, for example, when the grouping agent 210 communicates with the first communication group, the arrival time, arrival gate, baggage claim belt, connecting gate information, connecting flight status and/or the like may all be specific to the first aircraft 350 and the passengers thereon. Meanwhile, when the grouping agent 210 communicates with the second communication group, the arrival time, arrival gate, baggage claim belt, connecting gate information, connecting flight status and/or the like may all be specific to the second aircraft 360 and the passengers thereon.

The message protocols 346 may define message formats, triggering events for sending of specific messages, instructions for message creation, and/or the like. The content 342 may include games, video content, audio content, advertisements, and/or the like. Thus, for example, the message protocols 346 may define instructions for creating a message including content 342 that is to be extracted and formatted for service or delivery to members of the communication group 215. Alternatively or additionally, the message protocols 346 may define instructions for receiving information from the carrier 370 (either responsive to a request initiated by the grouping agent 210 or responsive to an unsolicited provision of such information) and extracting some or all of the information to be formatted for service or delivery to members of the communication group 215.

As can be appreciated from the descriptions above, the grouping agent 210 may be configured, in some cases, to define the communication group 215 (e.g., as a ring group) automatically on the ground or in the air based on the particular transportation asset with which all devices defining the communication group 215 are associated. When the transportation asset is an aircraft, this may include the pilot, passengers, crew, etc. However, the transportation asset could, in some cases, be another type of transportation asset such as a bus, train, ship, etc. After the communication group 215 is defined, all members of the communication group 215 may be contacted simultaneously by phone, SMS and/or the like via the group ID number assigned to the communication group 215.

The messaging that can be provided to the communication group 215 can have any of a number of functions or uses. For example, messaging may be provided to provide safety information regarding the aircraft directly to the devices of the passengers (e.g., safety videos). Emergency information could be provided to the passengers to provide instructions for preparation for or response to an emergency. Surveys may be provided to the communication group 215, and the surveys need not ask the passengers for flight information, since such information may be automatically determined. Instead, the passengers may merely be asked to answer questions regarding their flight without having to know anything specific about the flight, which may make survey participation easier and more likely to occur.

In some cases, the communication group 215 may be identified by a group identifier (i.e., one entry among the group identity information 344). The group identifier may be associated with each device ID of members of the communication group 215. Accordingly, the group identifier may be shared with the carrier 370 so that the carrier 370 can be aware of which passengers are aboard the carrier's transportation assets to generate appropriate messaging for the passengers. The carrier 370 could call the group identifier (or a phone number associated with the group identifier), send an SMS or other message to the group identifier (or a number or address associated with the group identifier) and have the phone call, SMS or other message routed to each device in the communication group 215 via the respective device IDs of those devices. In such examples, the content 342 and/or the schedule information 348 may be provided to the passenger by the carrier 370 and the grouping agent 210 may merely pass along the messages or be the conduit through which such messages flow. However, in other cases, the grouping agent 210 may intercede between the carrier 370 and the passenger to find out information the passenger may need from the carrier 370 without the carrier 370 ever knowing the identity of the passenger. In such examples, the carrier 370 may provide the schedule information 348 (including changes thereto) to the grouping agent 210 so that the grouping agent 210 can made decisions about the provision of messages to the passengers. It should also be understood that the grouping agent 210 may contact the communication group 215, with or without input from the carrier 370, in a similar manner to that which is described above.

Message preparation and delivery in connection with example embodiments is predicated on knowing that a particular passenger is on the transportation asset at a given time. Thus, message preparation and delivery is essentially based on knowing the location of the particular passenger. In some cases, the location information associated with the passenger may be as simple as knowing the passenger is on an aircraft (i.e., any aircraft). However, in some cases, the location information associated with the passenger may more specifically identify the specific aircraft on which the passenger is located. In still other situations, the location information may be specific to the actual current location or destination of the aircraft. For example, the schedule information may indicate flight destination. The estimated time of arrival may be compared to current time to determine an estimated distance from the flight destination to trigger certain messaging pertinent to arrival of the passenger. In still other cases, the aircraft itself may provide accurate location information instead of estimated position to also trigger specific messaging (e.g., for dining or beverage service information once cruising altitude is reached, for shopping or booking transportation, hotels, or other services at the flight destination (or ultimate destination of the passenger), for instructions to deplane, get baggage or clear customs as preparations for landing commence, etc.).

In any case, the communication group 215 is generally only defined for a predetermined period of time during which the corresponding devices are on or otherwise associated with the transportation asset. Thus, either based on scheduled arrival time, location, a combination of scheduled time and location, or other factors, the communication group 215 may be discontinued. In some cases, the communication group 215 may be scheduled ahead of time to be discontinued when some future time is reached. In some cases, survey materials may programmatically be provided to the communication group 215 immediately prior to the communication group 215 being discontinued. Likewise, other messages may programmatically be provided responsive to key events (initial contact, takeoff, landing, taxiing, etc.).

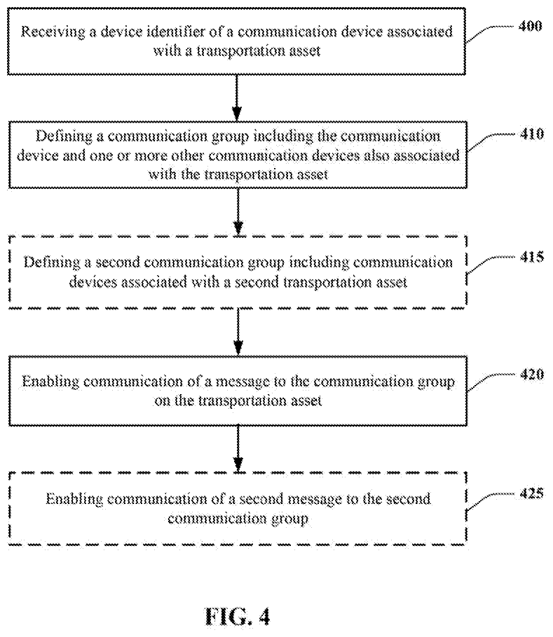

FIG. 4 illustrates a block diagram of one method that may be associated with an example embodiment as described above. From a technical perspective, the processing circuitry 310 described above may be used to support some or all of the operations described in FIG. 4. As such, the grouping agent described in connection with FIGS. 2 and 3 may be used to facilitate the implementation of several computer program and/or network communication based interactions. As an example, FIG. 4 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a device (e.g., the grouping agent 210, and/or the like) and executed by a processor in the device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include receiving a device identifier of a communication device associated with a transportation asset at operation 400. The method may further include defining a communication group including the communication device and one or more other communication devices also associated with the transportation asset at operation 410. The method may also include enabling communication of a message to the communication group on the transportation asset at operation 420.

In some embodiments, the method (and a corresponding apparatus configured to perform the method) may include (or be configured to perform) additional, optional operations, and/or the operations described above may be modified or augmented. Some examples of modifications, optional operations and augmentations are described below. It should be appreciated that the modifications, optional operations and augmentations may each be added alone, or they may be added cumulatively in any desirable combination. In an example embodiment, the method may further include defining a second communication group including communication devices associated with a second transportation asset at an optional operation 415. In some cases, the method may further include an additional optional operation of enabling communication of a second message to the second communication group at operation 425.

In some cases, defining the communication group may include defining the communication group for a predetermined period of time during which the communication device and the one or more other communication devices are associated with the transportation asset. In an example embodiment, the transportation asset may be an aircraft, and the predetermined period of time may be determined based on a scheduled flight time of the aircraft. In some examples, receiving the device identifier may include receiving the device identifier at a wireless access point located on the transportation asset. In some cases, defining the communication group may include associating a group identifier with the communication group such that each device identifier in the communication group is associated with the group identifier. Enabling communication of the message to the communication group may include addressing the message to the group identifier in order to deliver the message to each device identifier in the communication group. In an example embodiment defining the communication group may be performed at least in part based on location information associated with the transportation asset at a first time, and the communication group may be discontinued at a second time. Alternatively or additionally, the communication group may be discontinued based on location information associated with the transportation asset at the second time. In some cases, the second time may be a scheduled arrival time of the transportation asset. In an example embodiment, enabling communication of the message may include determining location information associated with the transportation asset and triggering the message to be communicated to the communication group based on the determined location information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A grouping agent comprising processing circuitry configured to:
receive a device identifier of a communication device associated with a transportation asset;
define a communication group including the communication device and one or more other communication devices also associated with the transportation asset; and
enable communication of a message to the communication group on the transportation asset.

2. The grouping agent of claim 1, wherein the processing circuitry is further configured to define a second communication group including communication devices associated with a second transportation asset.

3. The grouping agent of claim 2, wherein the processing circuitry is further configured to enable communication of a second message to the second communication group.

4. The grouping agent of claim 1, wherein defining the communication group comprises defining the communication group for a predetermined period of time during which the communication device and the one or more other communication devices are associated with the transportation asset.

5. The grouping agent of claim 4, wherein the transportation asset is an aircraft, and wherein the predetermined period of time is determined based on a scheduled flight time of the aircraft.

6. The grouping agent of claim 1, wherein receiving the device identifier comprises receiving the device identifier at a wireless access point located on the transportation asset.

7. The grouping agent of claim 6, wherein defining the communication group comprises associating a group identifier with the communication group such that each device identifier in the communication group is associated with the group identifier, and wherein enabling communication of the message to the communication group comprises addressing the message to the group identifier in order to deliver the message to each device identifier in the communication group.

8. The grouping agent of claim 1, wherein defining the communication group is performed at least in part based on location information associated with the transportation asset at a first time, and wherein the communication group is discontinued at a second time.

9. The grouping agent of claim 8, wherein the communication group is discontinued based on location information associated with the transportation asset at a second time.

10. The grouping agent of claim 8, wherein the second time is a scheduled arrival time of the transportation asset.

11. The grouping agent of claim 1, wherein enabling communication of the message comprises determining location information associated with the transportation asset and triggering the message to be communicated to the communication group based on the determined location information.

12. An air-to-ground (ATG) wireless communication network comprising:
an aircraft;
a plurality of base stations configured to communicate with the aircraft while the aircraft is in-flight; and
a grouping agent operably coupled to the aircraft, the grouping agent comprising processing circuitry configured to:
receive a device identifier of a communication device associated with the aircraft;
define a communication group including the communication device and one or more other communication devices also associated with the aircraft; and
enable communication of a message to the communication group on the aircraft.

13. The network of claim 12, wherein the processing circuitry is further configured to define a second communication group including communication devices associated with a second aircraft, and enable communication of a second message to the second communication group.

14. The network of claim 12, wherein defining the communication group comprises defining the communication group for a predetermined period of time during which the communication device and the one or more other communication devices are associated with the aircraft.

15. The network of claim 14, wherein the predetermined period of time is determined based on a scheduled flight time of the aircraft.

16. The network of claim 12, wherein receiving the device identifier comprises receiving the device identifier at a wireless access point located on the aircraft.

17. The network of claim 16, wherein defining the communication group comprises associating a group identifier with the communication group such that each device identifier in the communication group is associated with the group identifier, and wherein enabling communication of the message to the communication group comprises addressing the message to the group identifier in order to deliver the message to each device identifier in the communication group.

18. The network of claim 12, wherein defining the communication group is performed at least in part based on location information associated with the transportation asset at a first time, and wherein the communication group is discontinued at a second time.

19. The network of claim 18, wherein the communication group is discontinued based on location information associated with the transportation asset at a second time.

20. The network of claim 12, wherein enabling communication of the message comprises determining location information associated with the aircraft and triggering the message to be communicated to the communication group based on the determined location information.
